(19) United States
(12) Patent Application Publication
(10) Pub. No.: US 2016/0078491 A1
(43) Pub. Date: Mar. 17, 2016

(54) SYSTEM AND METHOD OF MARKETING OF REMINDERS

(71) Applicant: VOICEBOX TECHNOLOGIES CORPORATION, BELLEVUE, WA (US)

(72) Inventors: Michael R. KENNEWICK, SR., BELLEVUE, WA (US); Daniel B. CARTER, REDMOND, WA (US)

(73) Assignee: VOICEBOX TECHNOLOGIES CORPORATION, BELLEVUE, WA (US)

(21) Appl. No.: 14/855,339

(22) Filed: Sep. 15, 2015

Related U.S. Application Data
(60) Provisional application No. 62/051,282, filed on Sep. 16, 2014.
(60) Provisional application No. 62/051,288, filed on Sep. 16, 2014.

(51) Int. Cl. G06Q 30/02; G06Q 10/10

(52) U.S. Cl. CPC G06Q 30/0269; G06Q 10/1093; G06Q 30/0264

(57) ABSTRACT

In certain implementations, advertisers may be enabled to determine in real-time whether to include their advertisements (or other content) with reminders. As an example, the advertisement opportunity may be provided to the advertisers upon creation of the reminder. The advertisement opportunity may, for instance, comprise an opportunity to purchase an ad placement associated with the reminder. Upon determining that an advertiser purchased the associated ad placement, the associated ad placement may be allocated for an advertisement associated with the advertiser so that an advertisement associated with the advertiser may be presented with the reminder upon a triggering event indicating that the reminder should be presented to the user. When the reminder is provided for presentation to the user, a particular advertisement associated with the advertiser may be presented to the user.

### CROSS-REFERENCE TO RELATED APPLICATIONS

This application claims the benefit of U.S. Provisional Patent Application Ser. No. 62/051,282 filed Sep. 16, 2014 entitled “SYSTEM AND METHOD OF MARKETING OF REMINDERS” and U.S. Provisional Patent Application Ser. No. 62/051,288 filed Sep. 16, 2014 entitled “SYSTEM AND METHOD OF MARKETING OF USER REQUESTS”, the entireties of which are incorporated herein by reference.

### FIELD OF THE INVENTION

The invention relates to systems and methods of marketing of user requests and/or reminders (or other notifications).

### BACKGROUND OF THE INVENTION

Electronic user devices have emerged to become nearly ubiquitous in the everyday lives of many people. One of the reasons for this increased use is the convenience of receiving information with a user device. In an increasing global marketplace, advertisers are continually looking for new and effective ways to reach consumers. Recent technological advances in advertising include, for example, real-time bidding (RTB) of ad placements such that ad inventory is bought and sold on a per-impression basis. Typical ad bidding systems, however, do not provide advertisers with opportunities to purchase ad placements associated with individual user requests and/or reminders (or other notifications). These and other drawbacks exist.

### SUMMARY OF THE INVENTION

The invention relates to systems and methods of marketing of user requests and/or reminders (or other notifications). As an example, with respect to marketing of reminders, advertisers may be enabled to determine in real-time whether to include their advertisements (or other content) with reminders. To assist the advertisers in making such determinations, information about the reminders may be determined, and made available to the advertisers along with the advertisement opportunity (to include their advertisements with the reminders. Such information may, for instance, comprise a category related to a reminder, a location related to the reminder, a time related to the reminder, a device type of a device at which the reminder was made or at which the reminder will potentially be presented to a user, or other information. As used herein, an advertiser may comprise a business that is promoting their products or services, an independent marketer that is promoting products or services of other businesses, or other entity that is promoting products or services.

In an implementation, an advertisement opportunity associated with a reminder of a user may be provided to one or more advertisers (e.g., via a real-time bidding system). As an example, the advertisement opportunity may be provided to the advertisers upon creation of the reminder (e.g., without the need for further user input after creation of the reminder), and may comprise an opportunity to purchase an ad placement associated with the reminder. Upon determining that an advertiser purchased the associated ad placement, the associated ad placement may be allocated for an advertisement associated with the advertiser so that an advertisement associated with the advertiser may be presented with the reminder upon a triggering event indicating that the reminder should be presented to the user. Thus, when the reminder is provided for presentation to the user, a particular advertisement associated with the advertiser may also be presented to the user.

In an implementation, a reminder may be created based on a natural language input (e.g., utterance, gesture, etc.) of a user. As an example, if the user input is a natural language utterance spoken by the user, the utterance may be processed by a speech recognition engine to recognize one or more words of the utterance. The recognized words may then be processed (e.g., along with context information associated with the user) by a natural language processing engine to determine a user request intended by the user when the user spoke the utterance. In one use case, upon a determination that the user intends to create a reminder, the reminder is created on behalf of the user. In another use case, the determined user request may not specify creation of a reminder. Nevertheless, a need for a particular reminder may be predicted based on the processing of the natural language utterance. As a result, the reminder may be created on behalf of the user even though the user may not have intended to create the reminder (e.g., a reminder for his wedding anniversary may be created when the user has a conversation specifying a date or other time frame regarding his wedding anniversary).

In an implementation, as a result of the processing of the recognized words and/or the context information, one or more categories related to the utterance (e.g., product category, service category, etc.), entity associations related to the utterance (e.g., organization name, brand name, etc.,), product or service names related to the utterance, or other information may be determined. In one scenario, such information (determined based on the processing of the recognized words and/or context information) may be provided with (or included as part of) an advertisement opportunity associated with the reminder (that is created based on the utterance) to assist the advertisers in determining whether to include their advertisements (or other content) with the reminder.

In another scenario, such information (determined based on the processing of the recognized words and/or context information) may be utilized to select advertisers that are to be provided with an advertisement opportunity to include their advertisements (or other context) with the reminder (that is created based on the utterance). For example, the selection of the advertisers to be provided with the advertisement opportunity may be based on the likelihood (or the extent) that an advertiser would be interested in placing their advertisement with the reminder. Comparison of information regarding the advertisers (e.g., products or services offered by the advertisers, categories in which the advertisers have explicitly indicated interest, locations in or times during which the advertisers would like to promote their products or services, devices types with which the advertisers would like to promote their products or services, etc.) and information related to the utterance may, for instance, be performed to facilitate the selection of the advertisers to be provided with the advertisement opportunity.

Various other aspects of the invention will be apparent through the detailed description of the invention and the drawings attached hereto. It is also to be understood that both the foregoing general description and the following detailed description are exemplary and not restrictive of the scope of the invention. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 illustrates a system for marketing of user requests and/or reminders, according to an implementation of the invention.

FIG. 2 illustrates a system for facilitating natural language processing, according to an implementation of the invention.

FIG. 3 illustrates a data flow for a process of marketing user requests, according to an implementation of the invention.

FIG. 4 illustrates a data flow for a process of marketing reminders, according to an implementation of the invention.

FIG. 5 illustrates a flow diagram for a method of facilitating purchase of ad placements associated with user requests, according to an implementation of the invention.

FIG. 6 illustrates a flow diagram for a method of facilitating purchase of ad placements associated with reminders, according to an implementation of the invention.

FIG. 7 illustrates a screenshot of a user interface which provides an advertisement associated with an advertiser that purchased an ad placement associated with a user request, according to an implementation of the invention.

FIG. 8 illustrates a screenshot of a user interface which provides an advertisement associated with an advertiser that purchased an ad placement associated with a reminder, according to an implementation of the invention.

### DETAILED DESCRIPTION OF THE INVENTION

In the following description, for the purposes of explanation, numerous specific details are set forth in order to provide a thorough understanding of the implementations of the invention. It will be appreciated, however, by those having skill in the art that the implementations of the invention may be practiced without these specific details or with an equivalent arrangement. In other instances, well-known structures and devices are shown in block diagram form in order to avoid unnecessarily obscuring the implementations of the invention.

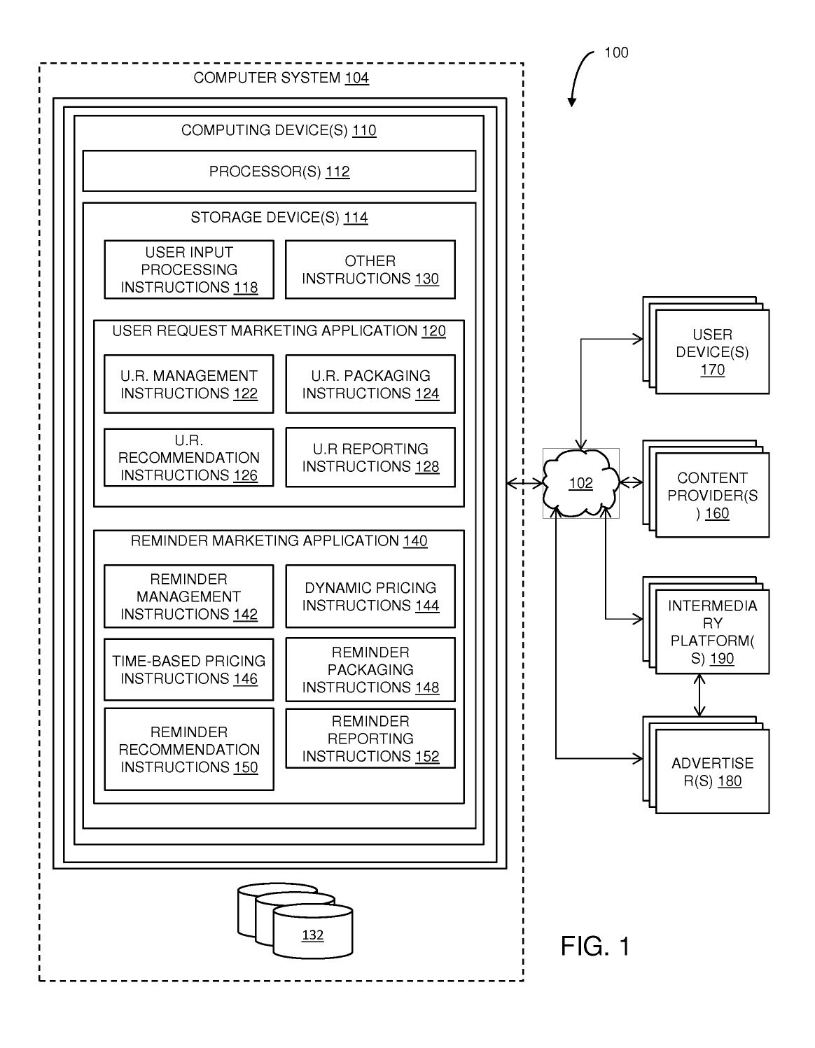

FIG. 1 illustrates a system 100 of marketing of user requests and/or reminders, according to an implementation of the invention. A user request may comprise a command, a query, or other user request. A reminder may relate to scheduled appointments, task deadlines, relevant dates/times, relevant user needs, or other items. Reminders may be created by users or automatically on behalf of users. As an example, a user may initiate creation of a reminder by submitting a user request specifying creating of the reminder. In another example, system 100 may automatically create a reminder on behalf of a user without a user request that specifies creation of the reminder. System 100 may, for instance, predict a need for a reminder for a user based on information about the user, such as the user's birthday, anniversary, appointments or other scheduled events, user requests submitted by the user (e.g., requests that do not necessarily specify creation of the reminder), or other information.

In an implementation, system 100 may provide one or more advertisement opportunities associated with one or more user requests and/or reminders (or other notifications) to one or more advertisers to facilitate purchase of ad placements with the user requests and/or reminders. As an example, the advertisement opportunities may comprise an opportunity to purchase an ad placement associated with a user request, an opportunity to purchase an ad placement associated with a reminder, or other opportunity. The advertisers may comprise businesses that are promoting their products or services, independent marketers that are promoting products or services of other businesses, or other entities that are promoting products or services.

In one use case, if an advertiser purchases an ad placement associated with a user request, the associated ad placement may be allocated for one or more advertisements associated with the purchasing advertiser such that an advertisement associated with the purchasing advertiser may be provided for presentation to the user as at least part of a response to the user request.

In another use case, if an advertiser purchases an ad placement associated with a reminder, the associated ad placement may be allocated for one or more advertisements associated with the purchasing advertiser such that an advertisement associated with the purchasing advertiser may be provided for presentation to the user with the reminder. An advertisement associated with the purchasing advertiser may, for instance, be presented to the user with the reminder upon receipt of an indication to present the reminder to the user (e.g., a user request to view the reminder, an automated trigger event to present the reminder to the user, or other indication).

In an implementation, system 100 may provide advertisers an opportunity to purchase real-time ad placements associated with user requests. For example, upon receipt a user input indicating a user request, system 100 may provide an opportunity to purchase an ad placement associated with the user request to one or more advertiser, and allocate the associated ad placement for an advertisement associated with a purchasing advertiser. System 100 may then provide a response to a user request of a user for presentation to the user such that the response comprises a first portion that addresses the user request of the user and a second portion that includes an advertisement associated with the purchasing advertiser. As such, before a response comprising a portion that addresses a user request of a user is provided for presentation to the user: (i) an opportunity to purchase an ad placement associated with the user request may be provided to an advertiser; and/or (ii) the associated ad placement may be allocated for an advertisement associated with the advertiser (e.g., upon the advertiser purchasing an associated ad placement) such that the response further comprises an advertisement associated with the advertiser when the response is provided for presentation to the user.

In an implementation, an advertiser may purchase an ad placement (e.g., associated with a user request, associated with a reminder, etc.) by accepting an active offer for the ad placement, by submitting the highest bid during an auction for the ad placement, etc. In some implementations, purchasing of an ad placement by an advertiser may comprise an intermediary (e.g., using an intermediary platform) accepting an active offer for the ad placement or submitting the highest bid for the ad placement on behalf of the advertiser (e.g., based on a pre-negotiated agreement between the intermediary and the advertiser).

In an implementation, an advertisement opportunity associated with a user request or a reminder may be provided to one or more advertisers based on a category associated with the user request or the reminder, a location associated with the user request or the reminder, a time associated with the user request or the reminder, a device type of a device at which the user request or a request for the reminder was made, a device type of a device at which a response to the user request or the reminder will potentially be presented to the user, or other parameter. In one scenario, for example, advertisers may be selected to receive the advertisement opportunity based on the likelihood (or the extent) that an advertiser would be interested in placing their advertisement as part of a response to the user request or with the reminder. Comparison of information regarding the advertisers and information related to the user request or the reminder may, for instance, be performed to facilitate the selection of the advertisers that are to receive the advertisement opportunity. As an example, information regarding the advertisers may comprise products or services offered by the advertisers, categories in which the advertisers have explicitly indicated interest, locations in or times during which the advertisers would like to promote their products or services, devices types (e.g., device operating system, device form factor, etc.) with which the advertisers would like to promote their products or services, or other information.

In another scenario, advertisers may indicate or be assigned to one or more categories of advertisement opportunities to facilitate distribution of advertisement opportunities to the advertisers. As an example, the indicated or assigned categories of each advertiser may be considered as at least one factor in determining which advertisement opportunities are to be provided to the advertiser (e.g., by determining the likelihood that the advertiser would purchase an ad placement associated with the advertisement opportunity). As another example, the indicated or assigned categories may be utilized to distribute advertisement opportunities to advertisers such that the advertisers only receive advertisement opportunities related to categories in which they have explicitly indicated interest or to which they have been assigned.

In an implementation, a purchase of an ad placement associated with a user request or a reminder by an advertiser may be based on a category associated the user request or the reminder, a location associated with the user request or the reminder, a time associated with the user request or the reminder, a device type of a device at which the user request or a request for the reminder is made, a device type of a device at which a response to the user request or the reminder will potentially be presented to the user, or other parameter. In one use case, for example, an intermediary platform (e.g., demand side platform) associated with a pizza restaurant may automatically accept offers of ad placements with user requests for food when the user requests are made from Sunday through Thursday (e.g., during which the pizza restaurant may be in need of customers), the user requests are made within 3 miles of the pizza restaurant, and the price of the ad placement is less than $0.25 (e.g., without user input specifying acceptance of those specific offers). In another use case, when the price of the ad placement is less than $0.50, an intermediary platform associated with a pizza restaurant may automatically accepts offers of ad placements with reminders regarding lunch or dinner that will potentially be presented to a user on a mobile phone (e.g., without user input specifying acceptance of those specific offers).

Other uses of system 100 are described herein and still others will be apparent to those having skill in the art. Having described a high level overview of some of the system functions, attention will now be turned to various system components that facilitate these and other functions.

### System Components

System 100 may include a computer system 104, one or more content providers 160, one or more user devices 170, one or more advertisers 180, an advertising intermediary platform 190 and/or other components. Computer system 104 may interface with content provider(s) 160 to allow users to access content offered by content provider(s) 160, one or more advertisers and/or an advertising intermediary 190 to provide advertisements for presentation to users, and various interfaces of the user device(s) 170 such that users may interact with computer system 104.

To facilitate these and other functions, computer system 104 may include one or more computing devices 110. Each computing device 110 may include one or more processors 112, one or more storage devices 114, and/or other components.

Processor(s) 112 may be programmed by one or more computer program instructions, which may be stored in storage device(s) 114. The one or more computer program instructions may include, without limitation, a user request marketing application 120 and a reminder marketing application 140. User request marketing application 120 and/or reminder marketing application 140 may themselves include different sets of instructions that each program the processor(s) 112 (and therefore computer system 104) to perform one or more operations described herein. For example, user request marketing application 120 may include user request marketing management instructions 122, user request packaging instructions 124, user request recommendation instructions 126, user request reporting instructions 128, and/or other instructions 130 that program computer system 104. Reminder marketing application 140 may include reminder marketing management application 142, dynamic pricing instructions 144, time-based pricing instructions 146, reminder packaging instructions 148, reminder recommendation instructions 150, reminder reporting instructions 152, and/or other instructions 130 that program computer system 104. Other applications may, of course, include one or more of the instructions 118-152 to perform one or more operations as described herein.

In some implementations, a given user device 170 may comprise a given computer device 110. As such, the given user device 170 may comprise processor(s) 112 that are programmed with one or more computer program instructions, such as user input processing instructions 118, user request marketing management instructions 122, user request packaging instructions 124, user request recommendation instructions 126, user request reporting instructions 128, reminder marketing management application 142, dynamic pricing instructions 144, time-based pricing instructions 146, reminder packaging instructions 148, reminder recommendation instructions 150, reminder reporting instructions 152, or other instructions 130.

In one implementation, one or more advertisers 180 may establish relationships with an intermediary platform 190 to allocate advertisements to the ad placements associated with the user requests and/or reminders. Intermediary platform 190 may serve as an intermediary between advertisers wishing to purchase ad placements and publishers wishing to find advertisers for unused/unsold advertising opportunities. Intermediary platform 190 may store advertisements and information provided by advertisers 180. For example, advertisements may be uploaded from advertisers to the intermediary platform 190 for display in the user request and/or reminders for which ad placements have been purchased. In an implementation, intermediary platform 190 may receive, negotiate, or accept advertisement opportunities offered by system 100 to the one or more advertisers 180. In an implementation, the one or more advertisers 180 and the intermediary platform 190 may have pre-negotiated agreements which enable the intermediary platform 190 to accept and provide advertisements to system 100 on behalf of the advertisers 180. For example, intermediary platform 190 may accept offers or submits bids on behalf of the advertisers 180 based on pre-negotiated agreements for purchasing ad placements associated with user requests and/or reminders.

As used hereinafter, for convenience, the foregoing instructions will be described as performing an operation, when, in fact, the various instructions may program processor(s) 112 (and thereafter computer system 104) to perform the operation. It should be appreciated that the various instructions are described individually as discreet sets of instructions by way of illustration and not limitation, as two or more of the instructions may be combined.

### User Input Processing

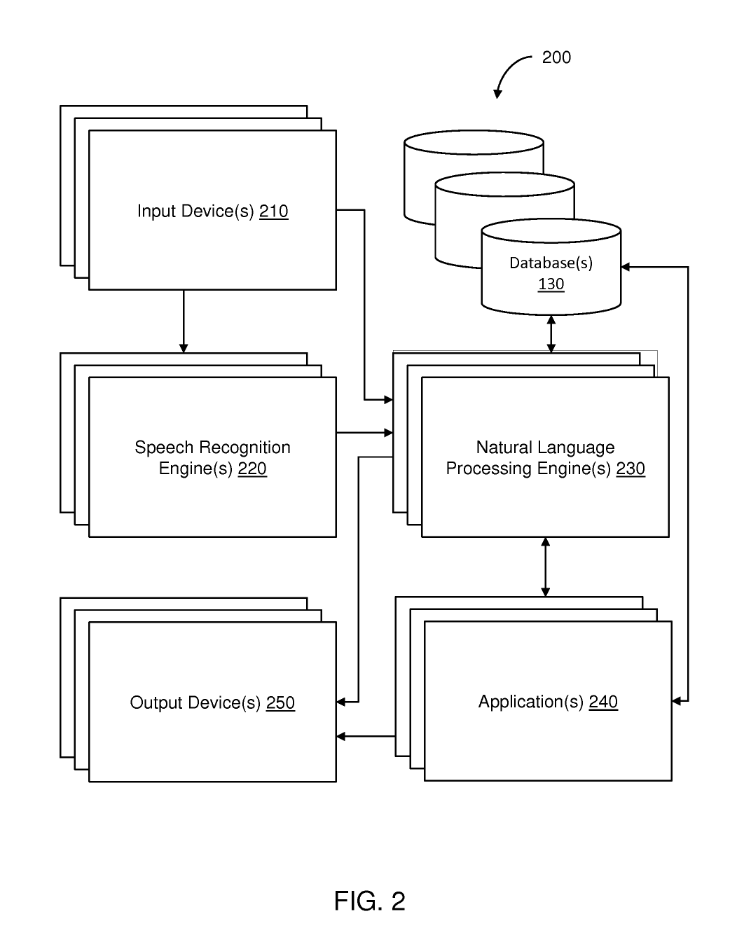

In an implementation, user input processing instructions 118 may process one or more user inputs of a user to determine one or more user requests that are intended by the user when the user provided the user inputs (e.g., creation of a reminder or other user request). The user inputs may comprise an auditory input (e.g., received via a microphone), a visual input (e.g., received via a camera), a tactile input (e.g., received via a touch sensor device), an olfactory input, a gustatory input, a keyboard input, a mouse input, or other user input. As described herein elsewhere, user input processing instructions 118 may comprise instructions associated with one or more speech recognition engines (e.g., speech recognition engine(s) 220 of FIG. 2), one or more natural language processing engines (e.g., natural language processing engine(s) 230 of FIG. 2), or other components for processing user inputs to determine user requests related to the user inputs.

In one use case, if the user input is a natural language utterance spoken by a user, the natural language utterance may be processed by a speech recognition engine to recognize one or more words of the natural language utterance. The recognized words may then be processed, along with context information associated with the user, by a natural language processing engine to determine a type of user request or reminder including one or more of a category associated with the user request or the reminder, a location at which the user request is made or with which the reminder is associated, a time at which the user request is made or with which the reminder is associated, a device type of a device at which the user request or the reminder was made, a device type of a device at which a response to the user request or the reminder will potentially be presented to the user, or other parameter.

FIG. 2 illustrates a system 200 for facilitating natural language processing, according to an implementation of the invention. As shown in FIG. 2, system 200 may comprise input device(s) 210, speech recognition engine(s) 220, natural language processing engine(s) 230, application(s) 240, output device(s) 250, database(s) 132, or other components.

In an implementation, one or more components of system 200 may comprise one or more computer program instructions of FIG. 1 and/or processor(s) 112 programmed with the computer program instructions of FIG. 1. As an example, speech recognition engine(s) 220 and/or natural language processing engine(s) 230 may comprise user input processing instructions 118 or other instructions 130 (e.g., grammar management instructions, profile management instructions, or other instructions).

Input device(s) 210 may comprise an auditory input device (e.g., microphone), a visual input device (e.g., camera), a tactile input device (e.g., touch sensor), an olfactory input device, a gustatory input device, a keyboard, a mouse, or other input devices. Input received at input device(s) 210 may be provided to speech recognition engine(s) 220 and/or natural language processing engine(s) 230.

Speech recognition engine(s) 220 may process one or more inputs received from input device(s) 210 to recognize one or more words represented by the received inputs. As an example, with respect to auditory input, speech recognition engine(s) 220 may process an audio stream captured by an auditory input device to isolate segments of sound of the audio stream. The sound segments (or a representation of the sound segments) are then processed with one or more speech models (e.g., acoustic model, lexicon list, language model, etc.) to recognize one or more words of the received inputs. Upon recognition of the words of received inputs, the recognized words may then be provided to natural language processing engine(s) 230 for further processing. In other examples, natural language processing engine(s) 230 may process one or more other types of inputs (e.g., visual input representing sign language communication, gestures, or other forms of communication) to recognize one or more words represented by the other types of inputs.

Natural language processing engine(s) 230 may receive one or more inputs from input device(s) 210, speech recognition engine(s) 220, application(s) 240, database(s) 132, or other components. As an example, natural language processing engine(s) 230 may process inputs received from input device(s) 210, such as user inputs (e.g., voice, non-voice, etc.), location-based inputs (e.g., GPS data, cell ID, etc.), other sensor data input, or other inputs to determine context information associated with one or more user inputs. As another example, natural language processing engine(s) 230 may obtain grammar information, profile information, context information, or other information from database(s) 132. The obtained information (or context information determined based on inputs from input device(s) 210) may be processed to determine one or more user requests associated with one or more user inputs of a user. In yet another example, natural language processing engine(s) 230 may process one or more recognized words from speech recognition engine(s) 220 and other information (e.g., information from input device(s) 210, application(s) 240, and/or database(s) 132) to determine one or more user requests associated with one or more user inputs of a user.

In an implementation, natural language processing engine(s) 230 may solicit further inputs from a user by responding with a request for more information via output device(s) 250 if, for instance, a user request associated with a user input of a user cannot be determined with sufficient confidence, more information would helpful to process the user request, etc.

In an implementation, upon determination of a user request of a user, natural language processing engine(s) 230 may determine an application 240 suitable for executing the user request, and provide the user request to the application for further processing. In one scenario, the application 240 may provide one or more results of the user request to output device(s) 250 for presentation to the user.

In another scenario, the application 240 may provide the results of the user request to natural language processing engine(s) 230 for further processing. As an example, the results of the user request may comprise intermediate results that are provided as a parameter for another user request of the user that is to be executed at another application 240. As such, the natural language processing engine(s) 230 may generate the other user request based on the intermediate results, and provide the other user request to the other application 240. As another example, natural language processing engine(s) 230 may formulate a natural language response based on the results received from the application 240, and provide the natural language response to output device(s) 250 for presentation to the user.

In an implementation, a given application 240 may obtain profile information, account information, or other information from database(s) 132 to authenticate a user before executing a user request of the user. As an example, the application 240 may be part of a given service provider. As such, the application 240 may determine whether the user has access to one or more services associated with the application 240 before executing the user request on behalf of the user.

In an implementation, a given application 240 may obtain content from database(s) 132 and/or content provider(s) 160 to provide one or more results of a user request of a user. In one use case, where the user request comprises a command to play a media item (e.g., song, video clip, movie, etc.), and the application 240 comprises a media stream application, the application 240 may obtain the media item from a given content provider(s) 160 and stream the media item to output device(s) 250 for presentation to the user.

In an implementation, natural language processing engine(s) 230, application(s) 240, or other components may store information in database(s) 132 for later use by natural language processing engine(s) 230, application(s) 240, or other components. As an example, as described in further detail elsewhere herein, natural language processing engine(s) 230 may store information regarding user inputs in database(s) 132 and/or update profile information, grammar information, or other information in database(s) 132 based on the information regarding the user inputs.

### User Request Marketing Management

In an implementation, user request marketing management instructions 122 may provide one or more advertisement opportunities related to user requests to one or more advertisers. As an example, a natural language utterance, a gesture (or other body movements), or other user input may be received from a user and processed to determine a user request related to the user input. Based on the user request, user request marketing management instructions 122 may provide one or more advertisement opportunity related to the user request to one or more advertisers.

In an implementation, user request marketing management instructions 122 may provide an advertiser with an opportunity to purchase ad placement with real-time user requests. Specifically, an ad placement associated with a user request may be offered to one or more advertisers (e.g., via an intermediary platform) in real-time as the user request is being processed and before a response addressing the user request is provided to the user. For example, in response to receiving a user request, user request marketing management instructions 122 may provide an advertiser an opportunity to purchase an ad placement located within a response to the user request before the response addressing the user request is provided to the user. An advertiser may, for instance, purchase the ad placement by being the first advertiser to accept an offer for the ad placement, by submitting the highest bid for the ad placement, etc. The offer and/or purchase of the ad placement may be based on a category associated with the user request, a location at which the user request is made, a time at which the user request is made, a device type of a device at which the user request was made or at which a response to the user request will potentially be presented to a user, or other parameter.

In an implementation, user request marketing management instructions 122 may provide an advertisement opportunity to advertisers based on parameters associated with the user request and parameters associated with the advertiser. For example, particular types of advertisement opportunities associated with user requests are presented to advertisers that seek to promote products or services related to the user requests. In one use case, user request marketing management instructions 122 may determine a category associated with the user request and provide an advertisement opportunity associated with the user request to only those advertisers that offer products or services related to the category associated with the user request. In another use case, the category associated with the user request may be utilized as at least one factor in determining which advertisers are to be provided with the associated advertisement opportunity.

In an implementation, user request marketing management instructions 122 may enable an advertiser (via an intermediary platform) to allocate an advertisement to an ad placement associated with the user request. For example, after purchasing an ad placement associated with a user request, an advertiser may allocate an advertisement to the ad placement so that the advertisement will be provided along with (or as part of) a response addressing the user request for presentation to a user that initiated the user request. In one use case, the allocated advertisement may be presented to the user before or after a response to the user request (or a portion thereof that addresses the user request) is presented to the user (e.g., where both the advertisement and the portion addressing the user request are provided in an audio format). In another use case, the allocated advertisement and the portion addressing the user request may be simultaneously presented to the user (e.g., on a web page).

### User Request Marketing Packages

In an implementation, user request packaging instructions 124 provide an advertiser with the opportunity to purchase one or more of a plurality of user request packages where each user request package may be associated with a certain number of ad placements with one or more types of user requests. For example, each type of user request may comprise one or more of a category associated with the user request, a location at which the user request is made, a time at which the user request is made, a device type of a device at which the user request was made or at which a response to the user request will potentially be presented to a user, or other parameter. User request packages may, for instance, be purchased using a store model, an auction model, or other model. In an implementation, user request packaging instructions 124 may provide the user request packages to advertisers based on parameters associated with the user request package and parameters associated with the advertiser. For example, particular types of user request packages are presented to advertisers that seek to promote related products or services.

### User Request Marketing Recommendations

In an implementation, user request recommendation instructions 126 may provide recommendations of user request packages for an advertiser based on parameters associated with the user request packages and parameters associated with the advertiser. As an example, an owner of a pizza restaurant may indicate that the pizza restaurant is in need of customers from Sunday through Thursday and that the pizza restaurant does not deliver. As such, the owner may be recommended user request packages that comprise ad placements with user requests related to a search for food that will be submitted by users from Sunday through Thursday while the users are at locations within 3 miles from the pizza restaurant.

### User Request Marketing Reporting

In an implementation, user request reporting instructions 128 may generate reports regarding user requests, and provide the reports to advertisers along with an opportunity to purchase recommended user request packages. For example, the reports may indicate the criteria used to determine the recommended user request packages for the advertisers (that are provided with the reports). In this way, advertisers will understand why certain user request packages are recommended for them, and may be enticed to purchase the recommended user request packages as a result.

Reports may, for instance, indicate the number or frequency of user requests (e.g., with respect to request type) location of requests, time of requests, device types of devices at which requests were made or later presented to users, click-through rate, return of investment, or other performance measurement of ad placements with user requests with respect to request type, etc. In one use case, an owner of a pizza restaurant may be recommended user request packages that comprise user requests related to upcoming sport games that will be submitted by users within 3 miles from the pizza restaurant. In addition, a report indicating that users who queried online for information regarding upcoming sports games while the users were within 3 miles from the pizza restaurant frequently purchase pizzas from nearby restaurants within a few hours of their informational queries.

### Reminder Marketing Management

In an implementation, reminder marketing management application 142 may provide one or more advertisement opportunities related to reminders to one or more advertisers. Reminders may, for example, relate to scheduled appointments, task deadlines, relevant dates/times, relevant user needs, or other items. Reminders may be created by users or automatically on behalf of users. As an example, a user may initiate creation of a reminder by submitting a user request specifying creating of the reminder. In another example, a reminder may be created on behalf of a user without a user request that specifies creation of the reminder. A need for a reminder may, for instance, be predicted for a user based on information about the user, such as the user's birthday, anniversary, appointments or other scheduled events, user requests submitted by the user (e.g., requests that do not necessarily specify creation of the reminder), or other information.

In an implementation, reminder marketing management application 142 may provide advertisers with an opportunity to purchase an ad placement associated with a reminder upon creation of the reminder. As an example, in response to a reminder being created, and without further user input after creation of the reminder, reminder marketing management instructions 142 may provide one or more advertisers an opportunity to purchase an ad placement located within the reminder. An advertiser may, for instance, purchase the ad placement by being the first advertiser to accept an offer for the ad placement, by submitting the highest bid for the ad placement, etc. The offer and/or purchase of the ad placement may be based on a category associated with the reminder, a location associated with the reminder, a time associated with the reminder, a device type of a device at which a request for the reminder was made or at which the reminder will potentially be presented to a user, or other parameter.

In an implementation, reminder marketing management application 142 provides the advertisement opportunity to advertisers based on parameters associated with the reminder and parameters associated with the advertiser. For example, particular types of advertisement opportunities associated with reminders are presented to advertisers that seek to promote products or services related to the reminders. In one use case, reminder marketing management instructions 142 may determine a category associated with the reminder and provide an advertisement opportunity associated with the reminder to only those advertisers that offer products or services related to the category associated with the reminder. In another use case, the category associated with the reminder may be utilized as at least one factor in determining which advertisers are to be provided with the associated advertisement opportunity.

In an implementation, reminder marketing management application 142 may enable an advertiser (via an intermediary platform) to allocate an advertisement to an ad placement associated with the reminder. For example, after purchasing the ad placement associated with a reminder, an advertiser may allocate an advertisement to the ad placement so that the advertisement will be provided along with (or as part of) the reminder for presentation to a user associated with the reminder.

### Dynamic Reminder Marketing

In an implementation, dynamic pricing instructions 144 may dynamically change prices associated with ad placement on a reminder based on length of time from creation of the reminder, length of time from an end time associated with the reminder (e.g., expiration of the reminder), length of time from a predetermined time (e.g., at which presentation of the reminder to the associated user is triggered), a number of remaining scheduled presentations of the reminder to the user (e.g., the number of times the reminder is scheduled to be automatically presented to the user before an end time associated with the reminder), etc.

In one use case, the price of placing an advertisement with a reminder may be decreased when there is only a certain amount of time left before expiration of the reminder (e.g., before the occurrence of the event associated with the reminder). As a result of the discounted price, the ad placement of the advertisement may remain (or become more) enticing for advertisers looking to purchase ad placements with reminders (e.g., even when their advertisement will only be placed with a reminder for a short period of time).

In another use case, the price of placing an advertisement with a reminder may be increased when there is only a certain amount of time left before expiration of the reminder. As an example, where advertisers are provided with the opportunity to purchase an ad placement with the reminder for immediate placement of their advertisement for a predetermined time period less than the remaining duration of the reminder, the last few days, hours, or other remaining time period associated with the reminder may be more valuable to advertisers than other time periods associated with the reminder.

In yet another use case, the price of placing an advertisement with a reminder may change as the number of remaining scheduled “alerts” associated with the reminder change. As an example, the price may decrease (or increase) as the number of remaining alerts decrease. As another example, the price may increase (or decrease) as the number of remaining alerts increase (e.g., if the user associated with the reminder modifies the number of alerts of the reminder after creation of the reminder). In this way, the price of the ad placement may reflect the anticipated number of times that an advertisement of a purchasing advertiser will be presented to the user associated with the reminder.

### Time-Based Reminder Marketing

In an implementation, time-based pricing instructions 146 may provide advertisers with the opportunity to purchase ad placement on reminders for a specified duration (e.g., a remaining time associated with the reminder, a predetermined time period less than the remaining time, etc.). An advertiser may, for instance, purchase an option to place advertisements for a few weeks, days, hours, etc., during which the reminder is still active. The available periods during which an advertisement can be placed with a reminder may comprise the beginning, the middle, the end, or other time period of the reminder.

In an implementation, time-based pricing instructions may set prices such that prices associated with ad placement on a reminder during one time period of the reminder may be different than prices associated with ad placement on the reminder during another time period (e.g., the last few days, hours, etc., associated with the reminder may be more expensive to purchase than other time periods of the reminder).

In an implementation, an ad placement with a reminder may end when the reminder is expired. For example, a reminder may expire when the event or user need related to the reminder is over. In an implementation, an advertisement may continue to be placed with a reminder even after the reminder's original expiration date if the expiration date of the reminder is extended. That is, the ad placement may dynamically be extended based on the extension of the reminder. As an example, an event associated with the reminder may be rescheduled for a later date, and the reminder (and its associated parameters) may be modified (e.g., automatically without user input specifying the modification to the reminder, manually by a user, etc.) to reflect the later date.

### Reminder Marketing Packages

In an implementation, reminder packaging instructions 148 may provide an advertiser with the opportunity to purchase one or more of a plurality of reminder packages where each reminder package may be associated with a certain number of ad placements with one or more types of reminders. For example, each type of reminder may comprise one or more of a category associated with the reminder, a location associated with the reminder, a time associated with the reminder (e.g., date, time of day, etc.), a device type of a device at which a request for the reminder was made or at which the reminder will potentially be presented to a user, or other parameter. User request packages may, for instance, be purchased via a store model, an auction model, or other model.

In an implementation, reminder packaging instructions 148 may provide the reminder packages to advertisers based on parameters associated with the reminder package and parameters associated with the advertiser. For example, particular types of reminder packages are presented to advertisers that seek to promote related products or services.

### Reminder Marketing Recommendations

In an implementation, reminder recommendation instructions 150 may provide recommendations of reminder packages for an advertiser based on parameters associated with the reminder packages and parameters associated with the advertiser. As an example, a tire retailer may be recommended reminder packages that comprise ad placements with reminders related to tire purchases based on a determination that the tire retailer sells tires (e.g., a reminder to replace tires when the associated user's tires reaches their treadlife). As another example, the reminder packages may be recommended for the tire retailer further based on a location of the tire retailer. In particular, for instance, the reminder packages may comprise ad placements with tired-purchase-related reminders associated with users that reside within a proximity threshold distance from the location of the tire retailer.

### Reminder Marketing Reporting

In an implementation, reminder reporting instructions 152 may generate reports regarding reminders, and provide the reports to advertisers along with an opportunity to purchase recommended reminder packages. For example, the reports may indicate the criteria used to determine the recommended reminder packages for the advertisers (that are provided with the reports). In this way, advertisements will understand why certain reminder packages are recommended for them, and may be enticed to purchase the recommended reminder packages as a result.

Reports may, for instance, indicate the number or frequency of reminders (e.g., with respect to reminder type, location, time, device types, or other parameters), location associated with the reminders, time associated with the reminders, device types of devices at which reminders were made or later presented to users, click-through rate, return of investment, or other performance measurement of ad placements with user requests with respect to request type, etc. In one use case, a tire retailer may be provided with a report that indicate the click-through rate and/or the return of investment of tire-related advertisements placed with tire-related reminders of users that reside near the tire retailer (e.g., within a proximity threshold distance). In addition, along with the report, the tire retailer may be recommended reminder packages that comprise ad placements with tire-purchase-related reminders of users that reside near the tire retailer.

### Examples of System Architectures and Configurations

Different system architectures may be used. For example, all or a portion of user request marketing application 120 and reminder marketing application 140 may be executed on a user device. In other words, computing device 110 as illustrated may include a user device operated by the user. In implementations where all or a portion of user request marketing application 120 and reminder marketing application 140 are executed on the user device, market user requests and reminders, and/or perform other functions/operations of user request marketing application 120 and reminder marketing application 140.

All or a portion of user request marketing application 120 and reminder marketing application 140 may be executed on a server device. In other words, computing device 110 as illustrated may include a server device that obtains a user request from a user device operated by the user. In implementations where all or a portion of user request marketing application 120 and reminder marketing application 140 are executed on the server device, market user requests and reminders, and/or perform other functions/operations of user request marketing application 120 and reminder marketing application 140.

Although illustrated in FIG. 1 as a single component, computer system 104 may include a plurality of individual components (e.g., computer devices) each programmed with at least some of the functions described herein. In this manner, some components of computer system 104 may perform some functions while other components may perform other functions, as would be appreciated. The one or more processors 112 may each include one or more physical processors that are programmed by computer program instructions. The various instructions described herein are exemplary only. Other configurations and numbers of instructions may be used, so long as the processor(s) 112 are programmed to perform the functions described herein.

It should be appreciated that although the various instructions are illustrated in FIG. 1 as being co-located within a single computing device 110, one or more instructions may be executed remotely from the other instructions. For example, some computing devices 110 of computer system 104 may be programmed by some instructions while other computing devices 110 may be programmed by other instructions, as would be appreciated. Furthermore, the various instructions described herein are exemplary only. Other configurations and numbers of instructions may be used, so long as processor(s) 112 are programmed to perform the functions described herein.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the instructions.

The various instructions described herein may be stored in a storage device 114, which may comprise random access memory (RAM), read only memory (ROM), and/or other memory. The storage device may store the computer program instructions (e.g., the aforementioned instructions) to be executed by processor(s) 112 as well as data that may be manipulated by processor(s) 112. The storage device may comprise floppy disks, hard disks, optical disks, tapes, or other storage media for storing computer-executable instructions and/or data.

The various components illustrated in FIG. 1 may be coupled to at least one other component via a network 102, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1 and other drawing Figures, different numbers of entities than depicted may be used. Furthermore, according to various implementations, the components described herein may be implemented in hardware and/or software that configure hardware.

User device(s) may include a device that can interact with computer system 104 through network 102. Such user device(s) may include, without limitation, a tablet computing device, a smartphone, a laptop computing device, a desktop computing device, a network-enabled appliance such as a “Smart” television, a vehicle computing device, and/or other device that may interact with computer system 104.

The various databases 132 described herein may be, include, or interface to, for example, an Oracle™ relational database sold commercially by Oracle Corporation. Other databases, such as Informix™, DB2 (Database 2) or other data storage, including file-based (e.g., comma or tab separated files), or query formats, platforms, or resources such as OLAP (On Line Analytical Processing), SQL (Structured Query Language), a SAN (storage area network), Microsoft Access™, MySQL, PostgreSQL, HSpace, Apache Cassandra, MongoDB, Apache CouchDB™, or others may also be used, incorporated, or accessed. The database may comprise one or more such databases that reside in one or more physical devices and in one or more physical locations. The database may store a plurality of types of data and/or files and associated data or file descriptions, administrative information, or any other data. The database(s) 132 may be stored in storage device 114 and/or other storage that is accessible to computer system 104.

### Example Flow Diagrams

The following flow diagrams describe operations that may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

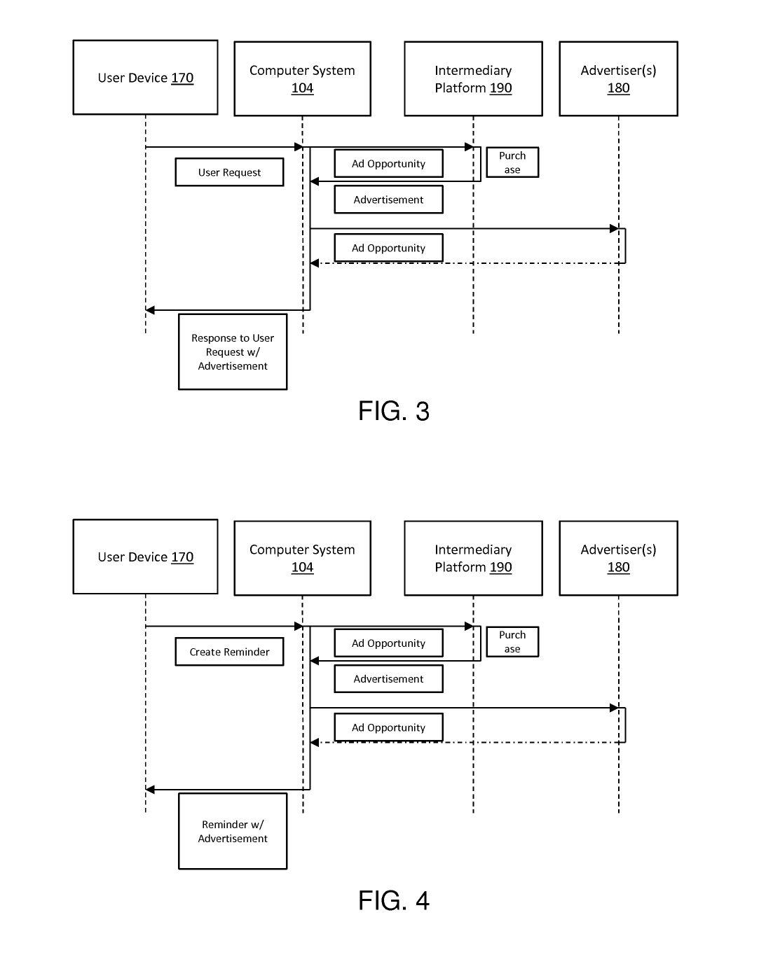

FIG. 3 illustrates a data flow for a process of marketing user requests, according to an implementation of the invention. The various processing data flows depicted in FIG. 3 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an implementation, a user request generated by a user device 170 may be provided to a computer system 104. In response to receiving the user request, the computer system 104 may provide an advertisement opportunity to an intermediary platform 190 and/or one or more advertisers 180. In response to purchasing the advertising opportunity (e.g., by an advertiser 180, by the intermediary platform 190 on behalf of the advertiser 180, etc.), the intermediary platform 190 and/or a purchasing advertiser 180 may provide an advertisement to the computer system 104. If the intermediary platform 190 and/or the advertisers 180 choose not to purchase the advertisement opportunity, the computer system 104 may not receive an advertisement from them. In response to receiving an advertisement from the intermediary platform 190 and/or the purchasing advertiser 180, the computer system 104 may provide a response to the user request with the advertisement to the user device 170.

FIG. 4 illustrates a data flow for a process of marketing reminders, according to an implementation of the invention. The various processing data flows depicted in FIG. 4 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an implementation, a reminder created by a user device 170 (or a request to create the reminder) may be provided to a computer system 104. In response to receiving the reminder (or the create request), the computer system 104 may provide an advertisement opportunity to an intermediary platform 190 and/or one or more advertisers 180. In response to purchasing the advertising opportunity (e.g., by an advertiser 180, by the intermediary platform 190 on behalf of the advertiser 180, etc.), the intermediary platform 190 and/or a purchasing advertiser 180 may provide an advertisement to the computer system 104. If the intermediary platform 190 and/or the advertisers 180 choose not to purchase the advertisement opportunity, the computer system 104 may not receive an advertisement from them. In response to receiving an advertisement from the intermediary platform 190 and/or the purchasing advertiser 180, the computer system 104 may provide the advertisement with the reminder for presentation to the user.

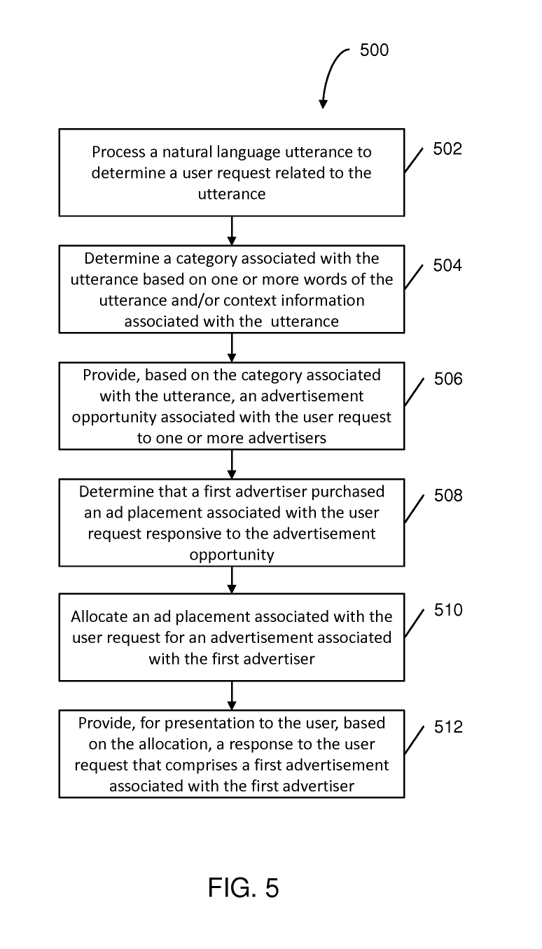

FIG. 5 illustrates a flow diagram for a method of facilitating purchase of ad placements associated with user requests, according to an implementation of the invention. The various processing data flows depicted in FIG. 5 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 502, a natural language utterance of a user may be processed to determine a user request related to the natural language utterance. As an example, a user input comprising the natural language utterance may be received and processed by a speech recognition engine to recognize one or more words of the natural language utterance. The recognized words may then be processed, along with context information associated with the user, by a natural language processing engine to determine the user request related to the natural language utterance.

In an operation 504, a category associated with the natural language utterance may be determined based on one or more words of the utterance, context information associated with the utterance, or other information. As a result of this determination, for instance, the user request (determined based on the natural language utterance) may be identified as being related to the category associated with the natural language utterance.

In an operation 506, an advertisement opportunity associated with the user request may be provided to one or more advertisers based on the category associated with the natural language utterance. For example, the advertisement opportunity may provide an advertiser an opportunity to purchase an ad placement associated with the user request with which the advertiser can place advertisements (or other content) to promote their products or services. The opportunity may, for instance, be provided to advertisers that have indicated an interest in purchasing ad placements associated with user requests related to the determined category. In one implementation, the advertisement opportunity may be provided to an advertiser in real-time as the user request is being processed and before a response addressing the user request is provided for presentation to the user.

In an operation 508, a determination that a first advertiser purchased an ad placement associated with the user request (responsive to the advertisement opportunity) may be effectuated. As an example, an advertiser may purchase an ad placement associated with the user request by accepting an active offer for the ad placement, by submitting the highest bid for the ad placement during an auction for the ad placement, etc. In some implementations, purchasing of an ad placement by an advertiser may comprise an intermediary (e.g., intermediary platform 190) accepting an active offer for the ad placement or submitting the highest bid on behalf of the advertiser (e.g., based on a pre-negotiated agreement between the intermediary and the advertiser).

In an operation 510, an ad placement associated with the user request may be allocated for an advertisement associated with the first advertiser. The allocation may, for instance, be based on the determination that the first advertiser purchased an ad placement associated with the user request.

In an operation 512, a response to the user request that comprises a first advertisement associated with the first advertiser may be provided for presentation to the user based on the allocation.

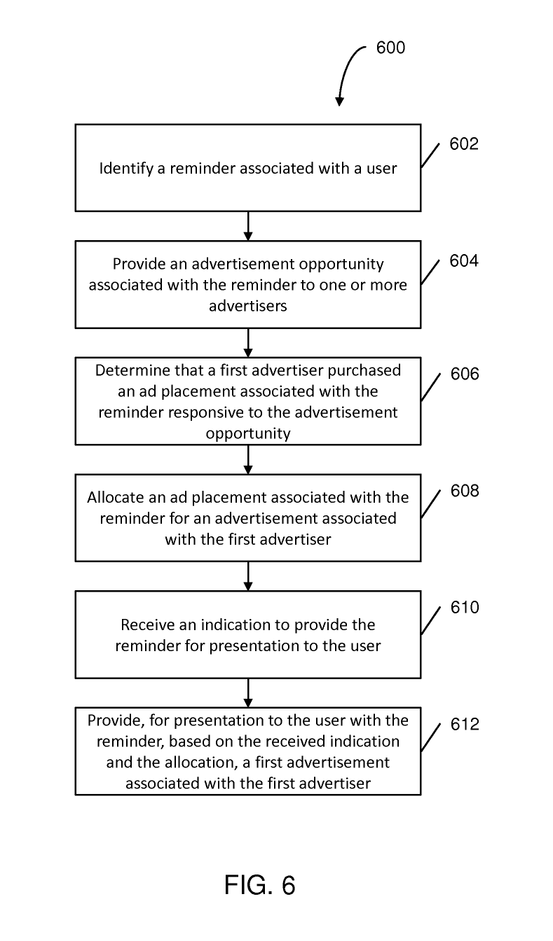

FIG. 6 illustrates a flow diagram for a method of facilitating purchase of ad placements associated with reminders, according to an implementation of the invention. The various processing data flows depicted in FIG. 6 (and in the other drawing figures) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 602, a reminder associated with a user may be identified. As an example, the identified reminder may have been created by the user or automatically created on behalf of the user without a user request to create the reminder. In one use case, with respect to user creation of a reminder, a user may initiate the creation of a reminder via speech, for instance, by providing a natural language utterance related to the reminder that the user desires to be created. The natural language utterance may be received and processed by a speech recognition engine to recognize one or more words of the natural language utterance. The recognized words may then be processed, along with context information associated with the user, by a natural language processing engine to create the reminder.

In an operation 604, an advertisement opportunity associated with the reminder may be provided to one or more advertisers. For example, the advertisement opportunity may provide an advertiser an opportunity to purchase an ad placement associated with the reminder with which the advertiser can place advertisements to promote their products or services. In one implementation, the price of an ad placement associated with the reminder may dynamically change based on a length of time from creation of the reminder, length of time from an end time associated with the reminder (e.g., expiration of the reminder), length of time from a predetermined time (e.g., at which presentation of the reminder to the associated user is trigger), a number of remaining scheduled presentations of the reminder to the user (e.g., the number of times the reminder is scheduled to be automatically presented to the user before an end time associated with the reminder), etc. In another implementation, the advertisement opportunity may comprise an opportunity to purchase an ad placement that allows for placement of an advertisement for a predetermined duration (e.g., less than a remaining time associated with the reminder, equal to the remaining time, etc.).

In an operation 606, a determination that a first advertiser purchased an ad placement associated with the reminder (responsive to the advertisement opportunity) may be effectuated. As an example, an advertiser may purchase an ad placement associated with the reminder by accepting an active offer for the ad placement, by submitting the highest bid for the ad placement during an auction for the ad placement, etc. In some implementations, purchasing of an ad placement by an advertiser may comprise an intermediary (e.g., intermediary platform 190) accepting an active offer for the ad placement or submitting the highest bid on behalf of the advertiser (e.g., based on a pre-negotiated agreement between the intermediary and the advertiser).

In an operation 608, an ad placement associated with the reminder may be allocated for an advertisement associated with the first advertiser. The allocation may, for instance, be based on the determination that the first advertiser purchased an ad placement associated with the reminder.

In an operation 610, an indication to provide the reminder for presentation to the user may be received. As an example, the indication may be based on a user request to view the reminder. As another example, the indication may be based on a time-based trigger (e.g., triggering on a periodic basis, at one or more predetermined times, etc.), a location-based trigger (e.g., triggering when the user is within proximity of one or more predetermined locations), a keyword-based trigger (e.g., triggering when one or more predetermined keywords are detected), or other trigger.

In an operation 612, a first advertisement associated with the first advertiser may be provided for presentation to the user with the reminder based on the received indication (to provide the reminder for presentation to the user) and the allocation.

### Example Screenshots

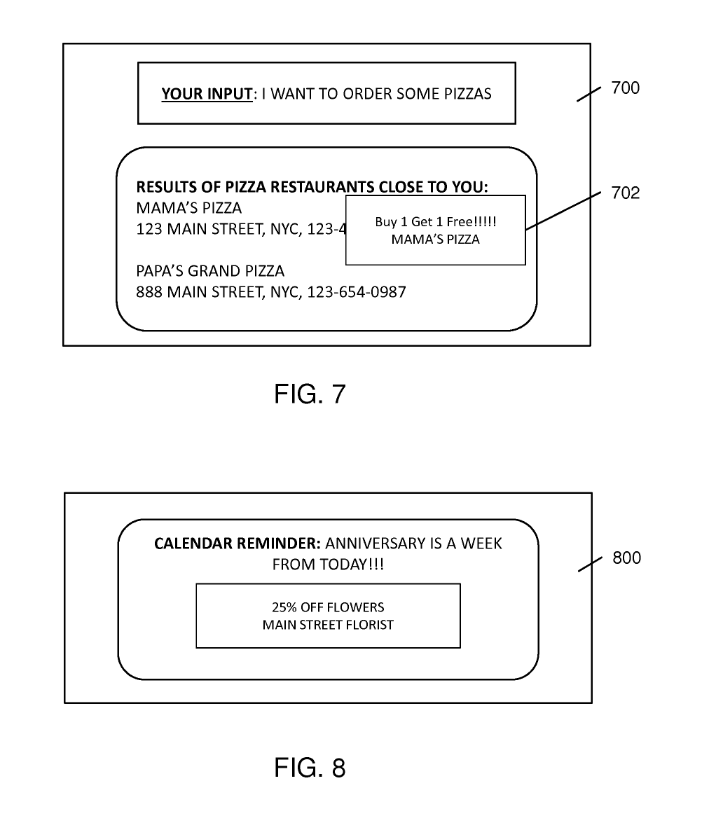

FIG. 7 illustrates a screenshot 700 of a user interface which provides an advertisement associated with an advertiser that purchased an ad placement associated with a user request, according to an implementation of the invention. The described screenshots may be accomplished using some or all of the system components described in detail above. With respect to screenshot 700, a user may provide a natural language input (e.g., natural language utterance or other input) indicating a user request to search for restaurants from which the user can order pizza. In response to the natural language input, an application associated with the depicted user interface may provide an advertisement opportunity related to the user request to one or more advertisers. As an example, the advertisement opportunity may enable advertisers to purchase an ad placement associated with the user request that allows a purchasing advertiser to place advertisements to market their products or services. If the advertisement opportunity is purchased by an advertiser, an advertisement associated with the advertiser may be provided in a response to the user request for presentation to the user. As depicted in screenshot 700, the response to the user request may include results for pizza restaurants nearby and an advertisement of a pizza deal for one of the nearby restaurants (e.g., Mama's Pizza). The advertisement may, for instance, be associated with a restaurant for which an intermediary purchased an ad placement associated with the user request.

FIG. 8 illustrates a screenshot 800 of a user interface which provides an advertisement which provides an advertisement associated with an advertiser that purchased an ad placement associated with reminder, according to an implementation of the invention. The described screenshots may be accomplished using some or all of the system components described in detail above. With respect to screenshot 800, a user may create a reminder to remind the user of an anniversary (e.g., wedding anniversary). In response to receiving a reminder request from the user, an application associated with the depicted user interface may provide an advertisement opportunity related to the reminder to one or more advertisers. As an example, the advertisement opportunity may enable advertisers to purchase an ad placement associated with the reminder that allows a purchasing advertiser to place advertisements to market their products or services. If the advertisement opportunity is purchased by an advertiser, an advertisement associated with the advertiser is provided in (or with) the reminder (e.g., for at least a predetermined number of times, a predetermined duration, etc.). As depicted in screenshot 800, the reminder may include a message about the user's upcoming anniversary and an advertisement providing a deal on flowers. The advertisement may, for instance, be associated with a business for which an intermediary purchased an ad placement associated with the reminder.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for facilitating purchase of ad placements associated with reminders, the method being implemented on a computer system having one or more physical processors programmed with computer program instructions which, when executed, perform the method, the method comprising:
identifying, by the computer system, one or more reminders associated with a user, wherein the one or more reminders comprise a first reminder for the user;
providing, by the computer system, an advertisement opportunity associated with the first reminder to one or more advertisers, wherein the advertisement opportunity comprises an opportunity to purchase an ad placement associated with the first reminder, and wherein the one or more advertisers comprise a first advertiser;
determining, by the computer system, that the first advertiser purchased an ad placement associated with the first reminder;
allocating, by the computer system, an ad placement associated with the first reminder for an advertisement associated with the first advertiser based on the determination that the first advertiser purchased an ad placement with the first reminder;
receiving, at the computer system, an indication to provide the first reminder for presentation to the user; and
providing, by the computer system, a first advertisement associated with the first advertiser with the first reminder for presentation to the user based on the received indication and the allocation.

2. The method of claim 1, wherein providing the advertisement opportunity comprises providing, without further user input after creation of the first reminder, the advertisement opportunity to the one or more advertisers.

3. The method of claim 2, wherein allocating an ad placement associated with the first reminder for an advertisement associated with the first advertiser comprises allocating, without further user input after the creation of the first reminder, an ad placement associated with the first reminder for an advertisement associated with the first advertiser.

4. The method of claim 2, wherein the first reminder is created based on a user request that specifies creating the first reminder.

5. The method of claim 2, wherein the first reminder is created without a user request that specifies creating the first reminder.

6. The method of claim 2, further comprising:
receiving, at the computer system, a natural language utterance;
performing, by the computer system, speech recognition on the natural language utterance to recognize one or more words associated with the natural language utterance; and
creating, by the computer system, the first reminder for the user based on the one or more recognized words.

7. The method of claim 6, further comprising:
determining, by the computer system, context information associated with the natural language utterance,
wherein creating the first reminder comprises creating the first reminder based on the one or more recognized words and the context information.

8. The method of claim 1, wherein providing the advertisement opportunity comprises providing the advertisement opportunity to the one or more advertisers based on one or more of a category associated with words of the reminder, a location associated with the reminder, a time associated with the reminder, or a device type of a device at which the reminder will potentially be presented to the user.

9. The method of claim 1, wherein determining that the first advertiser purchased an ad placement associated with the first reminder comprises determining that the first advertiser purchased an ad placement associated with the first reminder based on the first advertiser accepting a price associated with the advertisement opportunity.

10. The method of claim 1, wherein determining that the first advertiser purchased an ad placement associated with the first reminder comprises determining that the first advertiser purchased an ad placement associated with the first reminder based on the first advertiser placing a highest bid during an auction for an ad placement associated with the first reminder.

11. The method of claim 1, wherein providing the advertisement opportunity comprises providing, to the one or more advertisers, an opportunity to purchase an ad placement associated with the first reminder in exchange for a price that is based on at least one of a length of time from the creation of the first reminder or a length of time from an end time associated with the reminder.

12. The method of claim 1, wherein providing the advertisement opportunity comprises providing, to the one or more advertisers, an opportunity to purchase an ad placement associated with the first reminder in exchange for a price that is based on a number of remaining scheduled presentations of the first reminder to the user.

13. The method of claim 1, wherein providing the advertisement opportunity comprises providing, to the one or more advertisers, an opportunity to purchase an ad placement that allows for placement of an advertisement for a predetermined duration less than a remaining time associated with the first reminder.

14. A system for facilitating purchase of ad placements associated with reminders, the system comprising:
one or more physical processors programmed with computer program instructions which, when executed, cause the one or more physical processors to:
identify one or more reminders associated with a user, wherein the one or more reminders comprise a first reminder for the user;
provide an advertisement opportunity associated with the first reminder to one or more advertisers, wherein the advertisement opportunity comprises an opportunity to purchase an ad placement associated with the first reminder, and wherein the one or more advertisers comprise the first advertiser;
determine that the first advertiser purchased an ad placement associated with the first reminder;
allocate an ad placement associated with the first reminder for an advertisement associated with the first advertiser based on the determination that the first advertiser purchased an ad placement associated with the first reminder;
receive an indication to provide the first reminder for presentation to the user; and
provide a first advertisement associated with the first advertiser with the first reminder for presentation to the user based on the received indication and the allocation.

15. The system of claim 14, wherein providing the advertisement opportunity comprises providing, without further user input after creation of the first reminder, the advertisement opportunity to the one or more advertisers.

16. The system of claim 15, wherein allocating an ad placement associated with the first reminder for an advertisement associated with the first advertiser comprises allocating, without further user input after the creation of the first reminder, an ad placement associated with the first reminder for an advertisement associated with the first advertiser.

17. The system of claim 15, wherein the one or more physical processors are further caused to:
receive a natural language utterance;
perform speech recognition on the natural language utterance to recognize one or more words associated with the natural language utterance; and
create the first reminder for the user based on the one or more recognized words.

18. The system of claim 17, wherein the one or more physical processors are further caused to:
determine context information associated with the natural language utterance,
wherein creating the first reminder comprises creating the first reminder based on the one or more recognized words and the context information.

19. The system of claim 14, wherein providing the advertisement opportunity comprises providing, to the one or more advertisers, an opportunity to purchase an ad placement associated with the first reminder in exchange for a price that is based on at least one of a length of time from the creation of the first reminder or a length of time from an end time associated with the reminder.

20. The system of claim 14, wherein providing the advertisement opportunity comprises providing, to the one or more advertisers, an opportunity to purchase an ad placement associated with the first reminder in exchange for a price that is based on a number of remaining scheduled presentations of the first reminder to the user.
